(19) United States
(12) Patent Application Publication
(10) Pub. No.: US 2010/0074056 A1
(43) Pub. Date: Mar. 25, 2010

(54) OBSTACLE DETECTION DEVICE FOR DETECTING OBSTACLE

(75) Inventors: Taketo HARADA, Obu-city (JP); Masakazu TAKEICHI, Okazaki-city (JP); Muneaki MATSUMOTO, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/564,294

(22) Filed: Sep. 22, 2009

(30) Foreign Application Priority Data
Sep. 23, 2008 (JP) 2008-243460

(51) Int. Cl. G01S 15/00

(52) U.S. Cl. 367/93

(57) ABSTRACT

An obstacle detection device for detecting an obstacle includes: a transmitting and receiving element for transmitting and receiving an ultrasonic wave; an amplifier for amplifying a received signal corresponding to a received ultrasonic wave; and a gain controller for controlling a gain of the amplifier The gain controller increases the gain with time elapsed from a transmission time when the transmitting and receiving element transmits the ultrasonic wave. The gain controller starts to increase the gain at a rising time when reverberation caused by the transmitted ultrasonic wave is disappeared.

### CROSS REFERENCE TO RELATED APPLICATION

This application is based on Japanese Patent Application No. 2008-243460 filed on Sep. 23, 2008, the disclosure of which is incorporated herein by reference.

### FIELD OF THE INVENTION

The present invention relates to an obstacle detection device with an ultrasonic sensor for detecting an obstacle.

### BACKGROUND OF THE INVENTION

An obstacle detection device for detecting an obstacle is disclosed in JP-A-H05-232242. The device includes an ultrasonic sensor.

The ultrasonic sensor includes an ultrasonic wave transmitting and receiving element, a transmission signal circuit, an amplifier, a reception signal processor and a notification element. The transmission signal circuit outputs an ultrasonic pulse with a predetermined frequency intermittently to the ultrasonic wave transmitting and receiving element. The amplifier amplifies a reception signal, which is received by the ultrasonic wave transmitting and receiving element during an intermission between transmission of the ultrasonic wave and next transmission of the ultrasonic wave. The reception signal is amplified by the amplifier. The reception signal processor compares the amplified reception signal and a predetermined threshold value so that the processor detects an obstacle. The processor outputs an output signal to the notification element. The notification element informs existence of the obstacle based on the output signal. The processor includes a gain control signal circuit for reducing a gain of the amplifier by a predetermined level according to elapsed time during the intermission between the transmission and the next transmission.

In the above obstacle detection device, since the gain of the amplifier is reduced in accordance with the elapsed time, the device is not suitably used for detecting an object in a long distance area.

### SUMMARY OF THE INVENTION

In view of the above-described problem, it is an object of the present disclosure to provide an obstacle detection device with an ultrasonic sensor for detecting an obstacle. The device detects the obstacle in a long distance area and in a short distance area.

According to an aspect of the present disclosure, an obstacle detection device for detecting an obstacle includes: a transmitting and receiving element for transmitting and receiving an ultrasonic wave; an amplifier for amplifying a received signal corresponding to a received ultrasonic wave; and a gain controller for controlling a gain of the amplifier. The gain controller increases the gain with time elapsed from a transmission time when the transmitting and receiving element transmits the ultrasonic wave. The gain controller starts to increase the gain at a rising time when reverberation caused by the transmitted ultrasonic wave is disappeared.

In the above device, since the gain is increased with time, the device detects the obstacle in a long distance range. Further, since the gain is increased after the reverberation is disappeared, the device detects the obstacle in a short distance range.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an obstacle detection device according to an example embodiment;

FIG. 2 is a block diagram showing an ECU in the device;

FIG. 3 is a block diagram showing a sensor in the device;

FIG. 4 is a circuit diagram showing a reception circuit in the device;

FIG. 5 is a graph showing a relationship between time and a gain of the device;

FIG. 6 is a flowchart showing process executed by the device;

FIG. 7 is a graph showing a relationship between time and a gain according to a first modification of the example embodiment; and

FIG. 8 is a graph showing a relationship between time and a gain according to a second modification of the example embodiment.

### DETAILED DESCRIPTION OF THE PREFERRED EMBODIMENTS

An obstacle detection device according to an example embodiment will be explained as follows. The device is suitably used for a vehicle.

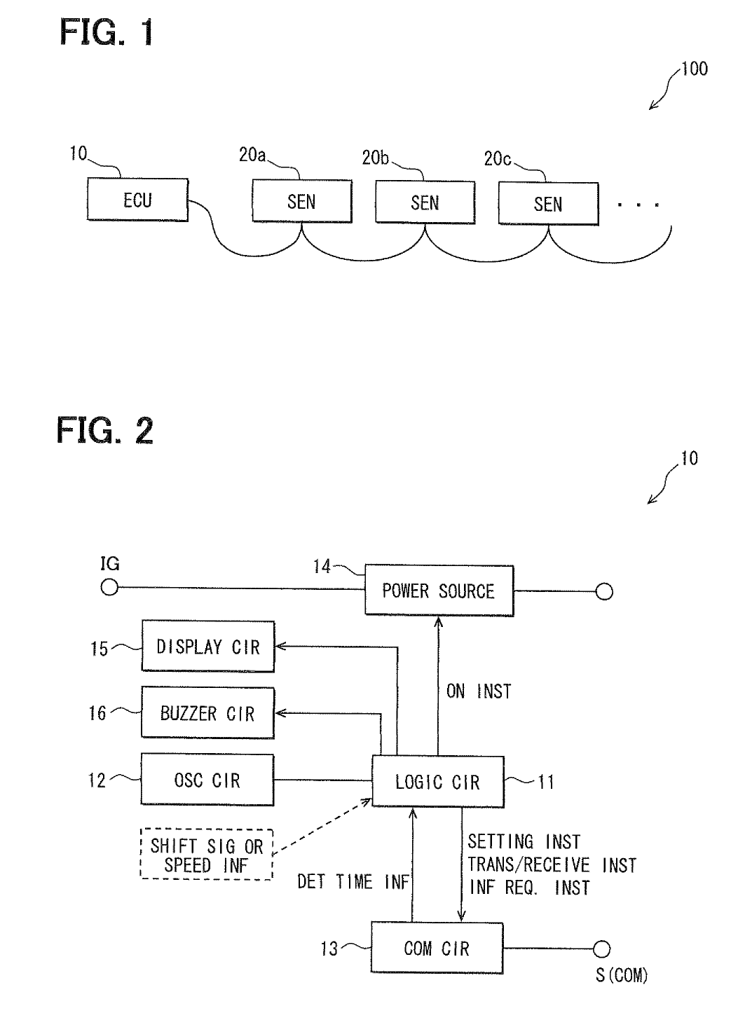

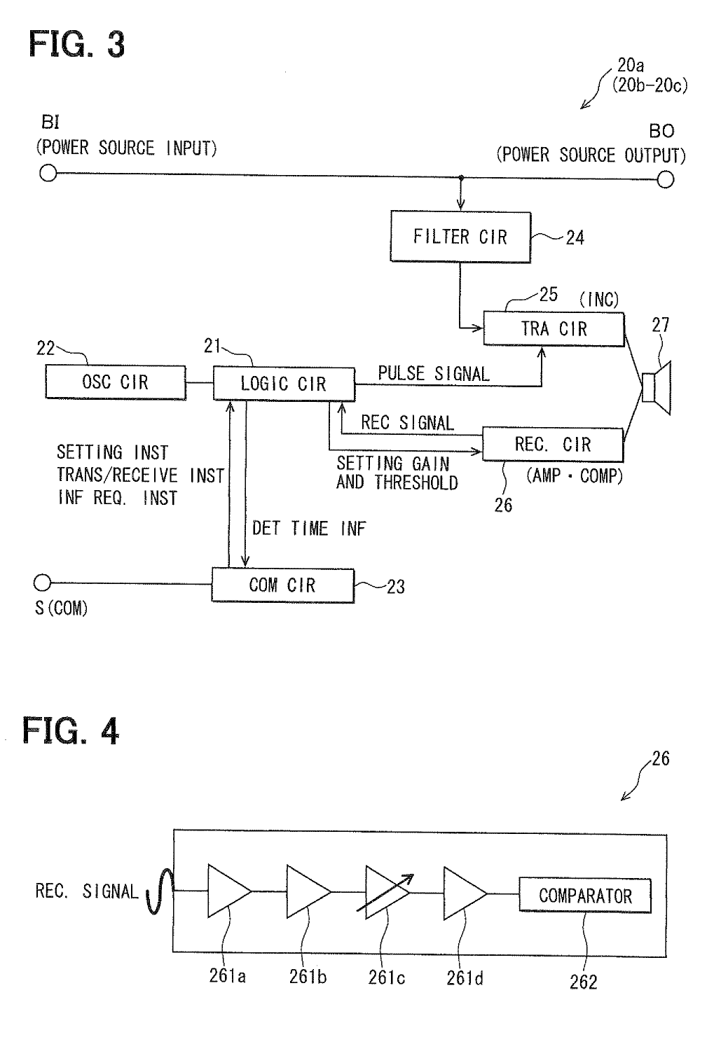

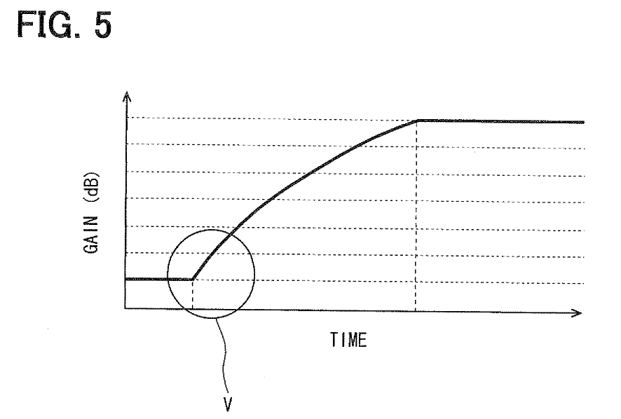

FIG. 1 shows the device. FIG. 2 shows an ECU in the device. FIG. 3 shows a sensor in the device. FIG. 4 shows a circuit diagram of a receiving circuit in the device. FIG. 5 shows gain change of the device.

In FIG. 1, the obstacle detection device 100 includes a ECU (Le., electronic control unit) 10 and multiple sensors 20a-20c. The ECU 10 is electrically coupled with the sensors 20a-20c via a communication line. The ECU 10 communicates the sensors 20a-20c with transmitting and receiving a communication frame, for example. In the embodiment, the sensors 20a-20c are coupled with the ECU 10 by a daisy chain connection. Alternatively, the sensors 20a-20c may be coupled with the ECU 10 by different connection. For example, the sensors 20a-20c may be coupled with the EUC 10 by direct connection or star type connection.

The ECU 10 includes a logic circuit 11 on an ECU side, an oscillation circuit 12, a communication circuit 13, a power source circuit 14 for the sensors 20a-20c, a display circuit 15, a buzzer circuit 16 and the like.

The logic circuit 11 functions based on the clock from the oscillation circuit 12. The logic circuit 11 transmits various communication frames to the sensors 20a-20c via the communication circuit 13 based on a shift signal and vehicle speed information. The communication frames includes information about an instruction for setting various sensors, an instruction for receiving and transmitting an ultrasonic wave, an instruction for requesting detection information, and the like. Further, the logic circuit 11 receives a detection result frame having information about detection time. The detection time is measured by the sensors 20a-20c. The detection time is defined by a time interval between transmission of the ultrasonic wave and reception of the ultrasonic wave. Thus, the obstacle detection device detects a position of the obstacle and a distance between the obstacle and the device. Here, the shift signal is input from a shift lever position sensor (not shown), and the vehicle speed information is input from a vehicle speed sensor (not shown). The shift lever position sensor and the vehicle speed sensor are external sensors.

The logic circuit 11 includes a non-volatile memory. An ID information of each sensor 20a-20c corresponding to a mounting position of the sensor 20a-20c and transmission frequency information of the ultrasonic wave are stored in the memory. Here, the ID information and the transmission frequency information are defined as a parameter. When the obstacle detection device is energized, i.e., is switched on, the logic circuit 11 transmits a parameter setting frame to the sensors 20a-20c in order of increasing a distance to the logic circuit 11. The parameter setting frame provides to set the parameter in the sensor 20a-20c. Then, when the parameter is set in the sensor 20a-20c correctly, the sensor 20a-20c outputs a parameter setting completion frame. The parameter setting completion frame is received by the logic circuit 11. Thus, a parameter setting process as an initial setting process is executed. The parameter setting frame may include information about a threshold value of a comparator 252, a gain of a STC amplifier circuit 261 and the like,

After the logic circuit 11 is switched on, the parameter setting process is executed. Thus, the sensor 20a-20c, in which the parameter is set normally, is operable. Further, the logic circuit 11 outputs an instruction for turning on to the power source circuit 14 so that the power source circuit 14 energizes the sensors 20a-20c.

The display circuit 15 is coupled with a display (not shown) such as a liquid crystal display. The display circuit 15 controls the display to display the position of the obstacle in real time according to the display instruction signal from the logic circuit 11. The position of the obstacle is determined by the logic circuit 11. Further, the buzzer circuit 16 is coupled with a sound output element such as a speaker as a notification element. The buzzer circuit 16 controls the sound output element to output sound such as a buzz according to a notification instruction signal from the logic circuit 11. The sound corresponds to the distance to the obstacle, which is detected by the logic circuit 11.

The sensor 20a-20c is a ultrasonic sensor mounted on a front side and a rear side of the vehicle. For example, the sensor 20a-20c is mounted on a bumper of the vehicle. The sensor 20a-20c detects the obstacle disposed in front of the vehicle or on a back of the vehicle. The sensor 20a-20c may have the same structure. Although the device includes three sensors 20a-20c, the device may include one sensor, two sensors or more than three sensors.

As shown in FIG. 3, the sensor 20a includes a logic circuit 21 on a sensor side, an oscillation circuit 22, a communication circuit 223, a filter circuit 24, a ultrasonic wave transmission circuit 25, a ultrasonic wave reception circuit 26, a microphone 27 and the like.

The logic circuit 21 functions based on a clock from the oscillation circuit 22. The logic circuit 21 receives various communication frames from the ECU 10 via the communication circuit 23. The various communication frames includes information about an instruction for setting the sensor, an instruction for transmitting and receiving the ultrasonic wave, detection information request instruction, and the like. Based on the communication frames, the logic circuit 21 outputs a transmission pulse signal to the transmission circuit 25, controls the reception circuit 26 to set a gain and a threshold value of the circuit 26. Further, the logic circuit 21 receives the reception signal waveform from the reception circuit 26. The logic circuit 21 calculates detection time information. The logic circuit 21 outputs detection result frame including the detection time information to the ECU 10 via the communication circuit 23. The transmission circuit 25 as a transmitting and receiving element is energized via the filter circuit 24.

The sensor 20a-20c receives the parameter setting frame including a parameter transmitted from the ECU 10. The received parameter is stored in the sensor 20a-20c. The transmission frequency included in the parameter is set as a frequency of the ultrasonic wave to be transmitted from the microphone 27. Further, when the parameter setting frame includes information about a threshold value of the comparator 262 and a gain of the STC amplifier circuit 261c, the sensor 20a-20c sets the threshold value of the comparator 262 and the gain of the STC amplifier circuit 261c based on the parameter setting frame. Thus, the sensor 20a-20c is operable by setting the parameter.

The microphone 27 as a transmitting and receiving element is mounted on the bumper of the front side or the rear side of the vehicle. Alternatively, the microphone 27 may be mounted on a different position of the vehicle. The microphone 27 outputs the ultrasonic wave and receives the ultrasonic wave in accordance with the instruction from the transmission circuit 25. The microphone 27 includes an oscillator (not shown). The oscillator performs ultrasonic oscillation so that the microphone 27 transmits the ultrasonic wave as a transmission wave. When the oscillator receives the ultrasonic wave, the oscillator vibrates. Based on the vibration of the oscillator, the microphone 27 receives the ultrasonic wave. Thus, the microphone 27 detects the reception wave. The microphone 27 is a conventional microphone.

The reception circuit 26 including an amplifier circuit will be explained as follows. The reception circuit 26 includes multiple amplifier circuits 261a-261d and a comparator 262, as shown in FIG. 4. Each amplifier circuit 261a-261d amplifies the reception signal received by the microphone 27.

The comparator 262 functions as a comparing element. The comparator 262 compares a signal received by the microphone 2 and amplified by the amplifier circuits 261a-261d with the threshold value. The comparator 262 outputs a signal level corresponding to comparison result. Specifically, the comparator 262 outputs a low level signal when the amplified signal is smaller than the threshold value. The low level signal represents that there is no obstacle around the vehicle. When the amplified signal is larger than the threshold value, the comparator 262 outputs a high level signal, which represents that there is the obstacle around the vehicle. The time when the comparator 262 outputs the high level signal is equal to the time when the device receives a reflection wave, which is reflected on the obstacle. Accordingly, the logic circuit 21 calculates the detection time information when the high level signal is output from the comparator 262 into the logic circuit 21. Specifically, the logic circuit 21 calculates the distance between the vehicle and the obstacle based on the time interval between a time when the transmission circuit 25 transmits the ultrasonic wave and a time when the high level signal is input into the logic circuit 21 and the speed of the ultrasonic wave. Thus, the logic circuit 21 calculates the detection time information.

One 261c of the amplifier circuits 261a-261d is a STC (sensitivity time control) amplifier circuit for increasing the gain according to the elapsed time from the time when the microphone 27 outputs the ultrasonic wave. Here, the elapsed time corresponds to the transmission distance of the ultrasonic wave. The relationship between the elapsed time and the gain in the STC amplifier circuit 261c is preliminary determined in view of the elapsed time, i.e., the distance and a damping rate. This relationship between the time and the gain is defined as a STC curve. The STC curve may be set in the sensor 20a-20c such that the STC curve is included in the parameter, which is set in the sensor 20a-20c by the ECU 10. Alternatively, the STC curve may be preliminary stored in the sensor 20a-20c, and the STC curve may be selected appropriately by an instruction from the ECU 10.

When the microphone 27 transmits the ultrasonic wave, the oscillator continues to vibrate inertially and mechanically. Thus, the inertial vibration as reverberation generates. Since the microphone 27 functions not only a transmitting element but also a receiving element, the microphone cannot detect the obstacle while the reverberation exists. Accordingly, the device cannot detect the obstacle in a short range. Thus, the device 100 starts to increase the gain of the STC amplifier circuit 261c at a time when the reverberation is disappeared.

The elapsed time from a time when the ultrasonic wave is output to a time when the reverberation ends can be estimated. Accordingly, the timing when the gain of the STC amplifier circuit 261c is increased is stored. The timing corresponds to the elapsed time from the time when the ultrasonic wave is transmitted. The logic circuit 21 outputs the instruction signal to the STC amplifier circuit 261c based on the memorized data so that the gain of the STC amplifier circuit 261c is increased.

Thus, as shown in FIG. 5, in the reception circuit 26 in the device 100, the gain starts to increase at the time V when the reverberation is disappeared, and then, the gain is increased with time along with the STC curve. Thus, the gain of the STC amplifier circuit 261c is increased with elapsed time from the time when the microphone 27 transmits the ultrasonic wave, so that the device 100 can detect the object in a long distance range. Further, the gain of the STC amplifier circuit 261c is increased after the reverberation is disappeared, so that the device 100 can detect the object in a short distance range. Thus, the device 100 can detect the obstacle near the vehicle and the obstacle far from the vehicle.

Here, the STC curve relating to the elapsed time and the gain in the STC amplifier circuit 261c and the timing when the gain starts to increase may not be constant. Alternatively, they may be varied.

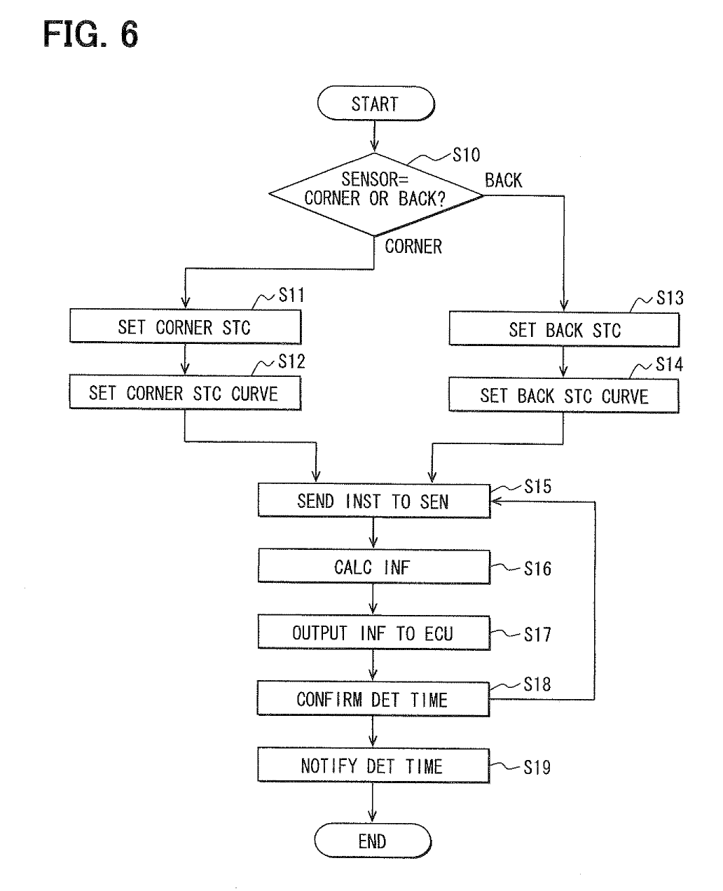

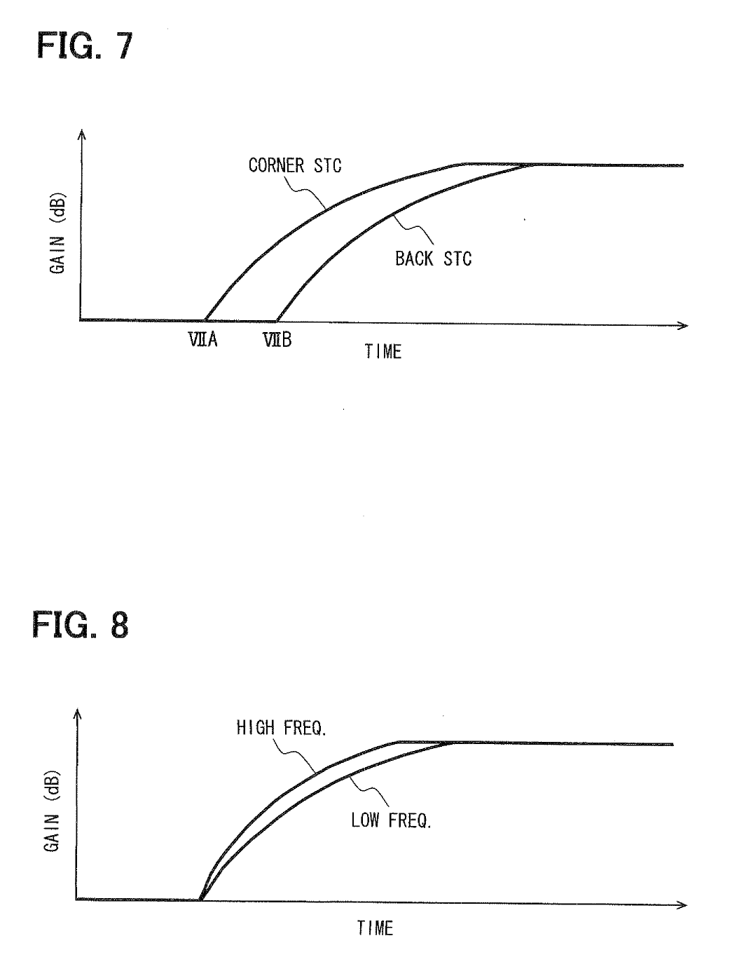

For example, the time V when the gain starts to increase, i.e., the time V of rising of the SCT curve may be varied according to the distance to the object. FIG. 6 is a flowchart showing process of the obstacle detection device according to a modification of the example embodiment. FIG. 7 shows variation of the rising time V of the gain in the device.

Multiple sensors in the device include a corner sensor as a short distance sensor and a back sensor as a long distance sensor. Specifically, the sensors 20a, 20b provide the corner sensor, and the sensor 20c provides the back sensor. Thus, the sensors 20a-20c transmit the ultrasonic wave to reach different distances.

The process shown in FIG. 6 is performed by the device 100. The process in the flowchart in FIG. 6 starts to execute at a time when an ignition switch turns on, and ends to execute at a time when the ignition switch turns off. Alternatively, when a shift lever is positioned at a reverse position (R), a drive position (D), a second speed position (2) or a low speed position (L), and the vehicle speed is equal to or smaller than 10 km/hr, the process may start to execute.

In Step S10, the ECU 10 (i.e., the logic circuit 11) determines whether the sensor 20a-20c is the corner sensor or the back sensor when the EUC 10 executes the parameter setting process such that the ECU 10 sets the ID of the sensors 20a-20c after the ignition switch turns on. When the ECU 10 determines that the sensor 20a-20c is the corner sensor, it goes to Step S11. When the ECU 10 determines that the sensor 20a-20c is the back sensor, it goes to Step S13.

In Step S11, the ECU 10 instructs to set the corner STC operation in the sensor 20a-20b, which is determined as the corner sensor. In Step S12, the sensor 20a-20b (i.e., the logic circuit 21) sets the corner STC curve instructed by the ECU 10 (i.e., the logic circuit 11) in the STC amplifier circuit 261c, Thus, the ECU 10 sets the STC curve for a short distance range in the sensor 20a-20b. The short distance range provides for a corner of the vehicle.

In Step S13, the ECU 10 instructs to set the back STC operation in the sensor 20c, which is determined as the back sensor. In Step S14, the sensor 20c (i.e., the logic circuit 21) sets the back SIC curve instructed by the ECU 10 (i.e., the logic circuit 11) in the STC amplifier circuit 261c. Thus, the ECU 10 sets the STC curve for a long distance range in the sensor 20c. The long distance range provides for a back of the vehicle.

The corner STC curve has the rising time VITA of the gain, which is different from the rising time VIIB of the back STC curve, as shown in FIG. 7. Here, in general, the convergence of the reverberation in case of the short distance range of transmission of the ultrasonic wave is faster than that in case of the long distance range of transmission of the ultrasonic wave. Thus, the rising time of the corner STC curve for setting in the corner sensor 20a-20b is faster than that of the back STC curve for setting in the back sensor 20c, Thus, the timing for increasing the gain in case of the short distance range is faster than that in case of the long distance range.

In Step S15, the ECU 10 transmits a communication frame having the transmitting and receiving instruction to the sensors 20a-20c via the communication circuit 13. In Step 516, the sensor 20a-20c receiving the transmitting and receiving instruction transmits and receives the ultrasonic wave, and then, the sensor 20a-20c amplifies the received wave according to the respective STC curve. Thus, the sensor 20a-20c calculates the detection time information.

In Step 517, the sensor 20a-20c (i.e., the logic circuit 21) transmits the detection time information to the ECU 10 (i.e., the logic circuit 11) via the communication circuit 23. In Step S18, the ECU 10 receives the detection time information via the communication circuit 13. Then, the ECU 10 (i.e., the logic circuit 11) confirms the detection time in the information. Here, Steps S15 to S18 are repeatedly executed.

In Step S19, the ECU 10 outputs the display instruction signal to the display circuit 15. Alternatively, or further, the ECU 10 outputs the notification instruction signal to the buzzer circuit. Thus, the sound and/or the image corresponding to the detection time, i.e., the distance between the vehicle and the obstacle are notified.

Thus, since the timing of increasing the gain in case of the short distance range is faster than that in case of the long distance range, the gain can be increased with appropriate timing.

FIG. 8 shows a gain change in the device according to a second modification of the example embodiment. In the device, the STC curve showing a relationship between the time and the gain is varied according to the frequency of the transmitting and receiving ultrasonic wave.

In the device, the sensors 20a-20c transmit and receive the ultrasonic wave having different frequencies.

In general, damping of the ultrasonic wave in case of high frequency is larger than that in case of low frequency. Accordingly, the gain corresponding to the high frequency is set to be larger than the gain corresponding to the low frequency. Thus, the gain can be set to fit the frequency. Here, the high frequency ultrasonic wave reaches a short distance range, and the low frequency ultrasonic wave reaches a long distance range.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An obstacle detection device for detecting an obstacle comprising:
a transmitting and receiving element for transmitting and receiving an ultrasonic wave;
an amplifier for amplifying a received signal corresponding to a received ultrasonic wave; and
a gain controller for controlling a gain of the amplifier,
wherein the gain controller increases the gain with time elapsed from a transmission time when the transmitting and receiving element transmits the ultrasonic wave, and
wherein the gain controller starts to increase the gain at a rising time when reverberation caused by the transmitted ultrasonic wave is disappeared.

2. The obstacle detection device according to claim 1,
wherein the transmitting and receiving element transmits the ultrasonic wave having multiple different transmission distances,
wherein the rising time depends on the transmission distance of the ultrasonic wave, and
wherein the rising time in case of a short transmission distance is faster than that in case of a long transmission distance.

3. The obstacle detection device according to claim 2,
wherein the transmitting and receiving element includes first and second transmitting and receiving elements,
wherein the first transmitting and receiving element transmits the ultrasonic wave having a first frequency, and the second transmitting and receiving element transmits the ultrasonic wave having a second frequency, which is higher than the first frequency, and
wherein the ultrasonic wave having the long transmission distance corresponds to the ultrasonic wave having the first frequency, and the ultrasonic wave having the short transmission distance corresponds to the ultrasonic wave having the second frequency.

4. The obstacle detection device according to claim 3,
wherein the amplifier includes first and second amplifiers,
wherein the first amplifier amplifies a received signal corresponding to the first transmitting and receiving element, and the second amplifier amplifies a received signal corresponding to the second transmitting and receiving element,
wherein the gain controller starts to increase the gain of the first amplifier at a first rising time, and increase the gain of the second amplifier at a second rising time, and
wherein an interval between the transmission time and the second rising time is smaller than an interval between the transmission time and the first rising time.

5. The obstacle detection device according to claim 1,
wherein the transmitting and receiving element transmits the ultrasonic wave having different frequencies,
wherein increase of the gain depends on the frequency of the ultrasonic wave, and
wherein the increase of the gain in case of a high frequency is larger than that in case of a low frequency.

6. The obstacle detection device according to claim 5,
wherein the transmitting and receiving element includes first and second transmitting and receiving elements,
wherein the first transmitting and receiving element transmits the ultrasonic wave having a first frequency, and the second transmitting and receiving element transmits the ultrasonic wave having a second frequency, which is higher than the first frequency, and
wherein the ultrasonic wave having the first frequency reaches a first transmission distance, and the ultrasonic wave having the second frequency reaches a second transmission distance, which is shorter than the first transmission distance.

7. The obstacle detection device according to claim 6,
wherein the amplifier includes first and second amplifiers,
wherein the first amplifier amplifies a received signal corresponding to the first transmitting and receiving element, and the second amplifier amplifies a received signal corresponding to the second transmitting and receiving element,
wherein the gain controller increases the gain of the first amplifier with a first rate, and increases the gain of the second amplifier with a second rate, and
wherein the first rate is smaller than the second rate.

8. The obstacle detection device according to claim 1,
wherein the gain controller includes a memory,
wherein the memory preliminary stores information about the rising time,
wherein the gain controller increases the gain along with a predetermined curve, which defines a relationship between elapsed time and the gain, and
wherein the memory further stores the predetermined curve.

9. The obstacle detection device according to claim 8,
wherein the amplifier is a sensitivity time control amplifier, and
wherein the predetermined curve is a sensitivity time control curve.
